(19) United States
(12) Patent Application Publication
(10) Pub. No.: US 2007/0241660 A1
(43) Pub. Date: Oct. 18, 2007

(54) DISPLAY

(76) Inventors: Keiji Suzuki, Yokohama-shi (JP); Kenji Sasaki, Yokohama-shi (JP); Yoshiyuki Kitahara, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/766,821

(22) Filed: Jun. 22, 2007

Related U.S. Application Data
(63) Continuation of application No. PCT/JP05/23236, filed on Dec. 19, 2005.

(30) Foreign Application Priority Data
Dec. 24, 2004 (JP) 2004-374555

(51) Int. Cl. H01J 63/04; H01J 1/62

(52) U.S. Cl. 313/497; 313/496; 313/495

(57) ABSTRACT

There is disclosed an SED formed by arranging a front substrate having a plurality of fluorescent layers and a metal back and a back substrate having a plurality of electron emitting elements and wiring lines for the elements so that the substrates face each other to join peripheral edge portions of the substrates to each other. The metal back is electrically divided into a plurality of island-like regions, and connected to a common electrode arranged around the regions. The common electrode has a plurality of electrode films separated from one another in a longitudinal direction of the common electrode and an annular resistance film. The resistance film is laminated thereon so as to electrically connect the plurality of electrode films to one another, and connected to an edge portion of the metal back.

### CROSS-REFERENCE TO RELATED APPLICATIONS

This is a Continuation Application of PCT Application No. PCT/JP2005/023236, filed Dec. 19, 2005, which was published under PCT Article 21(2) in Japanese.

This application is based upon and claims the benefit of priority from prior Japanese Patent Application No. 2004-374555, filed Dec. 24, 2004, the entire contents of which are incorporated herein by reference.

### BACKGROUND OF THE INVENTION

1. Field of the Invention

This invention relates to a display which emits electrons from electron emitting elements arranged on a back substrate to excite and illuminate fluorescent layers arranged on a front substrate, thereby displaying a color image.

2. Description of the Related Art

In recent years, as displays each having a vacuum envelope of a flat planar panel structure, a light crystal display, a field emission display (FED), a plasma display (PDP) and the like have been known. As one type of FED, a display including surface-conduction electron emitting elements (hereinafter referred to as an SED) is being developed.

The SED has a front substrate and a back substrate arranged so as to face each other, with a certain space being defined therebetween. Peripheral edge portions of these substrates are joined to each other via a rectangular frame-like side wall to constitute a vacuum envelope having a flat planar panel structure in which a vacuum is created.

An inner surface of the front substrate is provided with a fluorescent screen having three-color fluorescent layers and a metal back laminated on these layers. An inner surface of the back substrate is provided with a large number of electron emitting elements arranged in a row which emit electrons to excite and illuminate the fluorescent layers. Furthermore, on the inner surface of the back substrate, a large number of wiring lines for driving the electron emitting elements are arranged in a matrix form, and end portions of the lines are drawn out of the vacuum envelope.

Between the front substrate and the back substrate, a plurality of plate-like or pillar-like spacers are arranged. These spacers abut on the inner surfaces of the front substrate and the back substrate to withstand an atmospheric pressure load and to maintain a gap between the substrates.

In a case where this SED is operated, an anode voltage is applied to the metal back to apply a high voltage of about 10 [kV] between the substrates, whereby a driving voltage is selectively applied to the electron emitting elements via a driving circuit connected to the wiring lines. In consequence, electron beams are selectively emitted from the electron emitting elements, so that the corresponding fluorescent layers are irradiated with these electron beams, and the fluorescent layers are excited and illuminated to display a color image thereon.

In the SED structured as described above, an anode voltage of about 10 [KV] is applied between the front substrate and the back substrate which face each other via a micro gap of about 1 to 2 [mm], and therefore a problem of discharge often occurs between the substrates. If the discharge occurs between the substrates, a serious problem occurs in which electric charges developed on the whole surface of the metal back concentrate at a discharge portion, so that an excessively large discharge current flows, which destroys the electron emitting elements.

To solve the problem, a soft flash structure of the metal back has heretofore been known in which the metal back is divided into a plurality of elongated strip-like regions to reduce the electric charge concentration due to the discharge and to relieve the damage due to the discharge (e.g., see Jpn. Pat. Appln. KOKAI Publication No. 10-326583 (Paragraph [0210], FIG. 27)).

However, there has been a problem that, when a discharge occurs close to a position where one end of the metal back divided into the plurality of elongated regions is connected to a common electrode, an excessively large discharge current flows via the common electrode, which increases the damage caused by the discharge.

### BRIEF SUMMARY OF THE INVENTION

An object of this invention is to provide a display capable of suppressing damage due to discharges.

To achieve the above object, the display of this invention is characterized by comprising a vacuum envelope in which a front substrate and a back substrate are positioned so as to face each other and in which peripheral edge portions of the substrates are joined to each other to create a vacuum therein; the front substrate having a plurality of fluorescent layers, a metal back which covers these fluorescent layers and which is divided into a plurality of regions, and a common electrode which applies an anode voltage to these metal back regions; the back substrate having a plurality of electron emitting elements corresponding to the plurality of fluorescent layers; the common electrode being electrically divided into a plurality of regions.

Moreover, the display of this invention is characterized by comprising a vacuum envelope in which a front substrate and a back substrate are positioned so as to face each other and in which peripheral edge portions of the substrates are joined to each other to create a vacuum therein; the front substrate having a plurality of fluorescent layers, a metal back which covers these fluorescent layers and which is divided into a plurality of regions, and a common electrode which applies an anode voltage to these metal back regions; the back substrate having a plurality of electron emitting elements corresponding to the plurality of fluorescent layers; an electric resistance of the common electrode being several tens [KΩ] between two points which are most distant from each other.

According to the above invention, in a case where discharge occurs close to a connecting portion between the metal back divided into the plurality of regions and the common electrode, it can be prevented that an excessively large discharge current flows.

### BRIEF DESCRIPTION OF THE SEVERAL VIEWS OF THE DRAWING

FIG. 1 is a perspective view showing the appearance of a vacuum envelope of an SED according to an embodiment of this invention;

FIG. 2 is a perspective view of the section of the vacuum envelope cut along the line II-II of FIG. 1;

FIG. 3 is a partially enlarged sectional view showing a partially enlarged section of FIG. 2; and

FIG. 4 is an explanatory view of the structure of a metal back and a common electrode arranged on an inner surface of a front substrate.

### DETAILED DESCRIPTION OF THE INVENTION

An embodiment of this invention will hereinafter be described in detail with reference to the drawings.

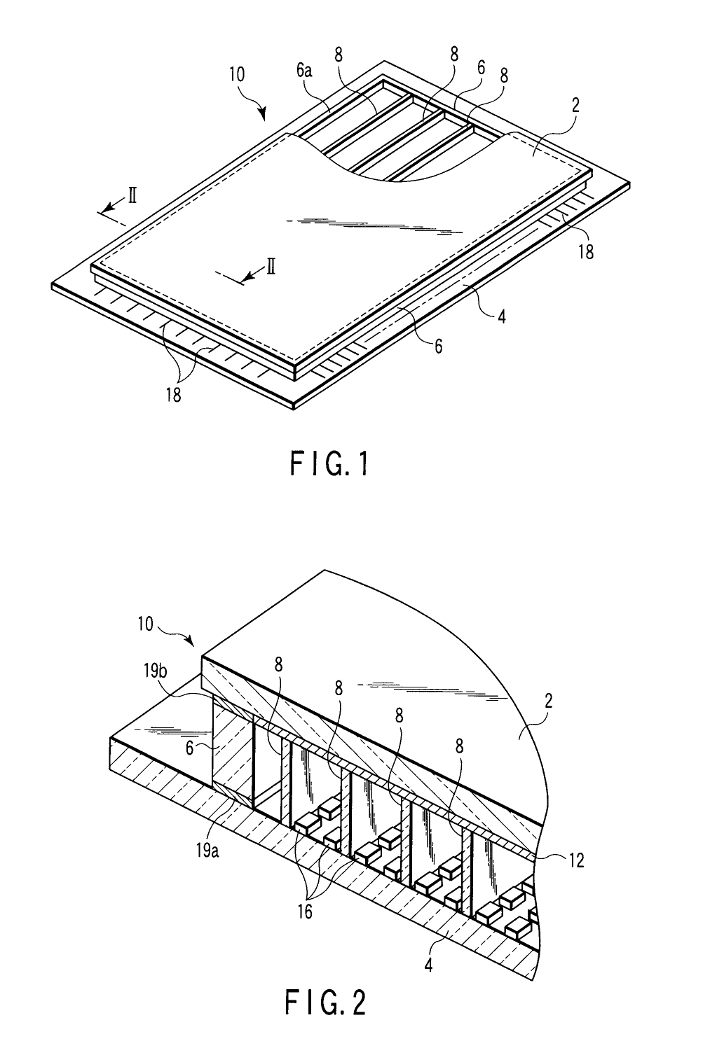

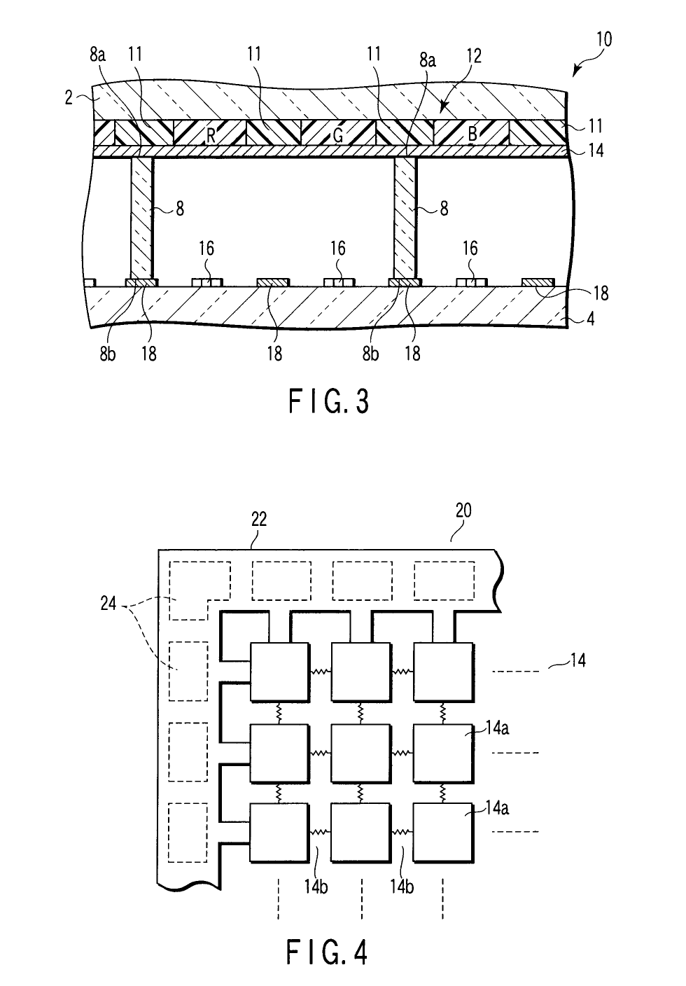

First, a surface-conduction electron-emitter display (SED) will be described as one example of a display according to the embodiment of the present invention with reference to FIGS. 1 to 3. FIG. 1 is a perspective view showing a vacuum envelope 10 (hereinafter referred to as a display panel 10 in some case) of the SED in which a front substrate 2 is partially cut out. FIG. 2 is a sectional view of the vacuum envelope 10 cut along the line II-II of FIG. 1, and FIG. 3 is a partially enlarged sectional view showing a partially enlarged section of FIG. 2.

As shown in FIGS. 1 to 3, the display panel 10 includes the front substrate 2 and a back substrate 4 which are formed of rectangular glass plates, respectively, and these substrates are arranged in parallel with each other so as to face each other with a space of about 1.0 to 2.0 mm therebetween. It is to be noted that the back substrate 4 has a somewhat larger size than the front substrate 2. The front substrate 2 and the back substrate 4 constitute a vacuum envelope having a flat planar panel structure in which peripheral edge portions of the substrates are joined to each other via a rectangular frame-like side wall 6 made of glass and in which a vacuum is created.

On an inner surface of the front substrate 2, a fluorescent screen 12 is formed which functions as an image display surface. This fluorescent screen 12 is constituted by arranging red, green and blue fluorescent layers R, G and B and shielding layers 11, and a metal back 14 made of aluminum or the like is laminated under them. The fluorescent layers R, G and B are formed into a stripe-like or dot-like shape.

An inner surface of the back substrate 4 is provided with a large number of surface-conduction electron emitting elements 16 which emit electron beams to excite and illuminate the fluorescent layers R, G and B of the fluorescent screen 12. These electron emitting elements 16 are arranged in a plurality of columns and rows corresponding to pixels, that is, the respective fluorescent layers R, G and B. Each of the electron emitting elements 16 includes an electron emitting section (not shown), a pair of element electrodes which apply a voltage to this electron emitting section, and the like. On the inner surface of the back substrate 4, a large number of wiring lines 18 are arranged in a matrix form to apply driving voltages to the respective electron emitting elements 16, and end portions of the wiring lines are drawn out of the vacuum envelope 10.

The side wall 6 which functions as a joint member is attached to the peripheral edge portions of the front substrate 2 and the back substrate 4 by use of a joint material 19 such as a low-melting glass or a low-melting metal to join these substrates to each other. In the present embodiment, the back substrate 4 is joined to the side wall 6 by use of a frit glass 19a, and the front substrate 2 is joined to the side wall 6 by use of an indium material 19b.

Moreover, the display panel 10 includes a plurality of elongated plate-like spacers 8 made of a glass between the front substrate 2 and the back substrate 4. In the present embodiment, a plurality of elongated glass plates are used as the spacers 8, but a large number of pillar-like spacers may be used.

Each of the spacers 8 has an upper end 8a which abuts on the inner surface of the front substrate 2 via the metal back 14 and the shielding layer 11 of the fluorescent screen 12 described above, and a lower end 8b which abuts on the wiring line 18 arranged on the inner surface of the back substrate 4. These spacers 8 withstand an atmospheric pressure load exerted from the exterior of the front substrate 2 and the back substrate 4, whereby a space between the substrates is kept at a constant value.

Furthermore, the SED includes a voltage supply section (not shown) which applies an anode voltage to the metal back 14 of the front substrate 2. For example, the voltage supply section applies a high voltage of about 10 [kV] to the metal back 14 to increase a potential of the fluorescent screen 12. In consequence, a potential difference of about 10 [kV] is formed between the back substrate 4, which is grounded, and the front substrate 2.

To display an image in the above SED, a voltage is applied between the element electrodes of each electron emitting element 16 via a driving circuit (not shown) connected to the wiring lines 18, so that electron beams are emitted from the electron emitting sections of electron emitting elements 16. At this time, the anode voltage is simultaneously applied to the metal back 14. The electron beams emitted from the electron emitting sections are accelerated by the anode voltage to irradiate the fluorescent screen 12. In consequence, the fluorescent layers R, G and B of the fluorescent screen 12 are excited and illuminated, so that a color image is displayed thereon.

Moreover, to manufacture the display panel 10 having the above structure, the front substrate 2 provided with the fluorescent screen 12 is previously prepared, and the back substrate 4 is then prepared which is provided with the electron emitting elements 16 and the wiring lines 18 and to which the side wall 6 and the spacers 8 is joined. Furthermore, the front substrate 2 and the back substrate 4 are arranged in a vacuum chamber (not shown), and the vacuum chamber is then evacuated. Afterward, the peripheral edge portions of the front substrate 2 and the back substrate 4 are joined to each other via the side wall 6.

In the SED having the above structure, the front substrate 2 and the back substrate 4 are arranged so as to face each other via a micro gap of about 1 to 2 [mm], with the intention of maintaining a very high vacuum therebetween. However, it is known that, for example, if a foreign object such as a piece of thin film sticks to any part of the wiring lines 18, the electron emitting elements 16 and the like, discharge occurs at the point of the foreign object as a base point between the substrates 2 and 4. At this time, when the metal back 14 is formed over the whole surface of the front substrate 2, almost all electric charges developed on the metal back 14 concentrate at the discharge position, and an excessively large discharge current flows, with the result that the electron emitting element 16 close to the discharge position is destroyed in some case.

To solve such a discharge problem, there is a known technology in which the metal back 14 is electrically divided into a plurality of regions in order to prevent the electric charges from concentrating at one point when a discharge occurs between the substrates. However, there is a problem that, when a discharge occurs close to a connecting portion between the common electrode for applying the anode voltage to the metal back 14 divided into the plurality of regions and an edge portion of the metal back 14, a discharge current flows into the edge portion of the metal back 14 via a resistance member which connects both of the members to each other, and the discharge current increases. To solve this problem, in the present embodiment, the common electrode arranged around the metal back 14 is improved as follows.

FIG. 4 is a schematic diagram showing a partially enlarged structure of the metal back 14 and a common electrode 20 arranged on the inner surface of the front substrate 2.

As shown in FIG. 4, the metal back 14 of the present embodiment is divided into a plurality of rectangular island-like regions 14a. More specifically, for example, the plurality of rectangular island-like regions 14a laminated on the fluorescent layers R, G and B (not shown herein) at a one-to-one ratio are formed in a matrix form, and the divided regions 14a are electrically connected to one another via resistance members 14b.

On the other hand, the common electrode 20 is annularly arranged so as to surround the metal back 14, and is connected to the edge portion of the metal back 14 via a resistance film 22 (a resistance member). In other words, the common electrode 20 has a plurality of electrode films 24 (conductive members) separated from one another in a longitudinal direction of the common electrode, the resistance film 22 is annularly laminated on the plurality of electrode films 24 to annularly connect the plurality of electrode films 24 to one another, and an inner periphery of the resistance film 22 projects to be connected to the edge portion of the metal back 14. The electrode films 24 are formed by, for example, patterning a silver paste.

When the electrode film 24 is electrically divided into the plurality of regions in this manner, an electric resistance of the common electrode 20 can be increased as compared with a case where the electrode films 24 are connected to one another in an annular form. It is to be noted that a resistance value of the common electrode 20 can arbitrarily be set in accordance with a length between the divided electrode films 24, a thickness and a width of each electrode film 24, a resistance value of the resistance film 22, and the like. In the present embodiment, the electrode films 24 and the resistance film 22 are designed so that an electric resistance between two diagonal points of the common electrode 20 (between two points which are most distant from each other) is several tens [KΩ]. In a case where such values are used for the electric resistance, even when a discharge occurs close to the connecting portion between the common electrode 20 and the metal back 14, it can be prevented that such an excessively large discharge current flows, which would otherwise destroy the electron emitting elements 16. It is to be noted that the value of several tens [KΩ] mentioned herein means 20 [KΩ] or more and less than 100 [KΩ].

As described above, according to the present embodiment, the common electrode 20 for applying the anode voltage to the metal back 14 is electrically divided into the plurality of regions, and therefore, in addition to a soft flash structure of the metal back 14, the common electrode 20 can also be formed into a soft flash structure. In consequence, even in a case where a discharge occurs close to the common electrode 20, the flow of an excessively large discharge current can be prevented, and destruction of the structure on a back substrate 4 side can be prevented.

It is to be noted that this invention is not limited to the above-mentioned embodiment as it is. In an implementation stage, the constituting elements may be modified and embodied without departing from the scope of the invention. Appropriate combinations of the plurality of constituting elements disclosed in the above embodiment can form various inventions. For example, several constituting elements may be removed from all of the constituting elements described in the above embodiment.

For example, the above embodiment has been described a case where the structure in which the electrode films 24 of the common electrode 20 are physically separated and connected to one another by the resistance film 22 is employed, but the present invention is not limited to this embodiment. A material of the electrode film 24 may appropriately be selected to design the electric resistance of the common electrode 20 at a desired value. Alternatively, a thickness and a width of the electrode film 24 may be changed to a desired electric resistance.

A display of this invention has a constitution and a function described above. Therefore, even when a discharge occurs between substrates, the flow of an excessively large discharge current can be prevented, and damage due to the discharge can be suppressed.

What is claimed is:

1. A display comprising a vacuum envelope in which a front substrate and a back substrate are positioned so as to face each other and in which peripheral edge portions of the substrates are joined to each other to create a vacuum therein;
the front substrate having a plurality of fluorescent layers, a metal back which covers these fluorescent layers and which is divided into a plurality of regions, and a common electrode which applies an anode voltage to these metal back regions;
the back substrate having a plurality of electron emitting elements corresponding to the plurality of fluorescent layers;
the common electrode being electrically divided into a plurality of regions.

2. The display according to claim 1, wherein the common electrode is arranged so as to surround the periphery of the metal back divided into the plurality of regions, and connected to the metal back via a resistance member.

3. The display according to claim 2, wherein the common electrode has a plurality of conductive members separated from one another in a longitudinal direction of the common electrode, and the resistance member connected to the metal back is laminated thereon so as to connect the plurality of conductive members to one another.

4. A display comprising a vacuum envelope in which a front substrate and a back substrate are positioned so as to face each other and in which peripheral edge portions of the substrates are joined to each other to create a vacuum therein;
the front substrate having a plurality of fluorescent layers, a metal back which covers these fluorescent layers and which is divided into a plurality of regions, and a common electrode which applies an anode voltage to these metal back regions;
the back substrate having a plurality of electron emitting elements corresponding to the plurality of fluorescent layers;
an electric resistance of the common electrode being several tens [KΩ] between two points which are most distant from each other.

5. The display according to claim 4, wherein the common electrode is arranged so as to surround the periphery of the metal back divided into the plurality of regions, and connected to the metal back via a resistance member.

6. The display according to claim 5, wherein the common electrode has a plurality of conductive members separated from one another in a longitudinal direction of the common electrode, and the resistance member connected to the metal back is laminated thereon so as to connect the plurality of conductive members to one another.
